(19) United States
(12) Patent Application Publication
(10) Pub. No.: US 2024/0222744 A1
(43) Pub. Date: Jul. 4, 2024

(54) Metal-Air Rechargeable Flow Battery

(71) Applicants: Media Lario s.r.l., Bosisio Parini (IT); Politecnico di Milano, Milano (IT)

(72) Inventors: Giuseppe Valsecchi, Oggiono (IT); Robert David Banham, Leiston (GB); Caterina Rigamonti, Cantù (IT); Luca Magagnin, Rho (IT)

(21) Appl. No.: 18/560,785

(22) PCT Filed: May 16, 2022
(86) PCT No.: PCT/EP2022/063196

§ 371 Date: Nov. 14, 2023

(30) Foreign Application Priority Data
May 14, 2021 (WO) PCT/EP2021/062855

(51) Int. Cl. H01M 12/08; H01M 4/42; H01M 4/86; H01M 8/18; H01M 16/00

(52) U.S. Cl. CPC H01M 12/08; H01M 4/42; H01M 4/8652; H01M 8/18; H01M 16/006

(57) ABSTRACT

The Zinc air cell is circular and includes a chamber for the electrolyte flowing, a cathode, an anode, a container structure of the electrolyte chamber and a cathode current collector. A contact element electrically connects the cathode to the anode current collector of the adjacent cell to close the circuit. This Zinc-Air rechargeable flow battery cell includes at least one carbon porous air electrode (positive electrode) for the synthesis of oxygen reduction reaction (ORR)/oxygen evolution reaction (OER). Furthermore, it includes an alkaline gel polymeric membrane (GPM) with hydroxide ion conductivity or a composite polymer electrolyte (CPE), and at least one metal negative electrode including zinc or zinc alloy or an inert conductive electrode where zinc deposition occurs during battery discharging. An aqueous electrolyte solution is adapted to flow through a housing and containing a zinc-based nanoelectrofuel. The carbon porous air electrode is an oxygen reduction reaction (ORR) catalyst. There is casing in which said components are positioned, and an inlet and an outlet are located within and traverse said casing and are constructed to permit the exchange of the aqueous electrolyte in the cell and in the reservoir.

### CROSS-REFERENCE TO RELATED APPLICATIONS

This application is the United States national phase of International Patent Application No. PCT/EP2022/063196 filed May 16, 2022, and claims priority to International Patent Application No. PCT/EP2021/062855 filed May 14, 2021, the disclosures of which are hereby incorporated by reference in their entireties.

### BACKGROUND OF THE INVENTION

### Field of the Invention

The integration of intermittent sources of renewable energy such as wind and solar energy is a challenge from the point of view of the meeting between supply and demand of energy and the stability and functioning of the electricity grid.

### Description of Related Art

Due to the limitations of current technologies, there is a demand for cost-effective chemical energy storage for large-scale applications. A promising example under development is the metal air flow battery. Metal air batteries (MABs) could prove to be a key technology for ensuring energy security, high specific capacity, low cost and easy scalability of renewable generation.

Among the metal-air batteries, zinc-air battery technology is the most popular. In particular, zinc air flow batteries (ZABs) are based on very cheap active materials, like zinc, which is widely available on the market, safe and environmentally friendly.

In a common metal-air battery, the metal is used as an anode, a liquid electrolyte is used as electrolyte, an air cathode is used as a cathode, and oxygen in the air is used as a cathode active material. In the metal air battery, it is not necessary to incorporate the cathode active material in the battery because oxygen present in the air is used as the cathode active material. Since on one side of the battery, i.e. the positive electrode, the active material is air, basically massless, this technology can reach extremely high energy densities, practically between 350 and 1100 Wh/kg, which is higher than the current state of the art for Li-ion batteries. Accordingly, in principle, the battery has the largest energy density among chemical batteries.

According to an aspect of the present invention, there is provided a zinc-air cell comprising:
at least one porous carbon air electrode (positive electrode) for the synthesis of oxygen reduction reaction (ORR)/oxygen evolution reaction (OER);
an alkaline gel polymeric membrane (GPM) with hydroxide ion conductivity;
at least one metal negative electrode comprising zinc or zinc alloy;
an aqueous electrolyte solution adapted to flow through the housing.

The electrochemical reactions involved in a Zn-air battery are:

$$\{ \begin{matrix}Negative side : Zn + 4 {OH}^{-} \to {Zn ( OH )}_{4}^{2 -} + 2 {e}^{-} ( {E}_{0} = - 1 \text{.25} V ) \\ Positive side : 1 / {20}_{2} + {H}_{2} O + 2 {e}^{-} \to 2 {OH}^{-} ( {E}_{0} = 0.34 V ) \\ Overall : 2 Zn + {O}_{2} \to 2 ZnO ( Δ {E}_{0} = 1.59 V )\end{matrix}$$

In summary, an overall theoretical open circuit voltage (OCV) of 1.59 V is obtained.

In the state of the art, Pan, J. et al. [Electrochemistry Communications, 2009, 11, 2191-2194] describes a zinc airflow battery in which a liquid electrolyte is stored in an external reservoir and recirculated through the internal passage of the battery, while the electrodeposited zinc is used as negative electrode. Publication XP055965215 of Wan Lei et al. discloses a “Janus-Typed Integrated Bifunctional Air Electrode with MnOx—NiFe LDH/Ni Foam for Rechargeable Zinc-Air Batteries”. The catalyst comprises MnOx (x=1, 2) for ORR, in a mixed respective electrodes and a membrane. A ion-exchange membrane (IEM) is disclosed, e.g. a well-known gel polymer electrolyte in this filed. Such batteries are widely known for use in vehicles or energy storage facilities. WO 2016/031201 of Sharp K K [JP] discloses a zinc-air flow battery with Zn-based nanoelectrofuel, comprising an alkaline zinc half-cell containing a zinc-based nanoelectrofuel half-cell, with Zn particles, in a size of, e.g., 1 rim, and a concentration of 15M or 30M, i.e. falling within 10-40% by volume. Furthermore, carbon particles are dispersed in the nanoelectrofuel with a concentration of e.g., 2.5 wt. º/0-10 wt. %. The catalyst is protected by a hydrophobic layer of Teflon. The electrolyte further inevitably contains at least zincates, such as Zn(OH)₂ being an alkaline electrolyte and ZnO, as KOH or NaOH with 6M or 12M. The positive electrode is an air cathode, i.e. having air as active material and comprises a catalyst layer, e.g. Pt/C, i.e., an ORR/OER catalyst material for efficient air conversion and a gel polymer electrolyte. The device contains several Zn-air cells with an inlet and an outlet.

However, various problems have hampered the commercial acceptance of Zn-air batteries. One of the known limitations for a zinc-based rechargeable battery is having a reversible zinc redox reaction, especially in an alkaline environment. This is due to the ease of passivation of the zinc surface with the formation of an insulating layer of ZnO during the discharge phase, and to the ease of dendritic growth of zinc during the charging phase.

The use of a flux battery significantly reduces the problem associated with dendrite formation and shape changes, as galvanized ions are continuously recirculated through the battery system.

Furthermore, in order to suppress the formation of dendrites, it is also proposed to add inhibitors for the formation of dendrites within the electrolyte solution.

The zinc-air battery (ZAB) proposed here is characterized by an integrated flow system that allows to reduce these problems and therefore allowing the ZAB a very high cyclicality and operating life.

Other limiting factors of known Zinc-air batteries are:
leakage and evaporation of electrolyte solution
leakage and evaporation of the solvent (water)

The cathode is intrinsically porous, which causes the electrolyte to gradually escape over time, this event combined with the capillary action results in the formation of water on the back of the electrode. This can also result in the formation of crystalline KOH which reacts with CO₂ to precipitate the K₂CO₃ solids. These alkaline carbonates gradually move within the cathode porosity and block the passage of air with a consequent decrease in battery performance and life.

### SUMMARY OF INVENTION

Considering this technical background, it is the object of the present invention to provide a rechargeable battery with improved energy density, in particular up to 10-15 times the energy density of a typical Vanadium Redox Flow Battery (VRB) and up to more than 2-5 times the energy density of a Lithium-ion battery storage device, improved durability, in that this battery should provide a long lifetime of at least 10 years, with minimal maintenance and remain stable over a period up to of 5000-15000 cycles without appreciable losses of the capacity, and low cost with respect to other zinc-air flow batteries of the state of art. The object of the present invention is therefore an upgrade for the resolution of the classic problems relating to a ZAB and furthermore, it is an object of the present invention to provide a suitable apparatus for charging said battery.

This object is attained by a Zinc-Air rechargeable flow battery having a zinc-air cell comprising:
at least one air electrode as positive electrode for the synthesis of oxygen reduction reaction ORR and oxygen evolution reaction OER,
an alkaline gel polymeric membrane GPM with hydroxide ion conductivity or a composite polymer electrolyte CPE,
at least one metal negative electrode comprising zinc or zinc alloy or an inert conductive electrode where zinc deposition occurs during battery discharging, this conductive electrode made of carbon/graphite, based materials, stainless steel, silver, gold, platinum, titanium and alloys of these,
an aqueous electrolyte solution adapted to flow through the housing,
   characterized in that the air electrode is a porous carbon air electrode acting as an oxygen reduction reaction ORR catalyst and consisting of manganese oxide, and the oxygen evolution reaction OER catalyst consisting of iron nickel oxyhydroxide NiFeOOH, and the electrolyte containing a zinc-based nanoelectrofuel.

The object is furthermore attained by an apparatus for charging a zinc-air rechargeable flow cell or a zinc-air rechargeable flow battery, said apparatus containing: the zinc-air cell/battery, a reservoir, said reservoir comprising a zinc-containing electrolyte fluid, at least one external pump to drain the electrolyte fluid, a manifold and other piping components to allow the flow of the electrolyte, whereby said reservoir of said apparatus is located externally to a device containing zinc-air cell or zinc-air battery for which charging is desired and said pump is operationally connectible to said device and facilitates the draining of electrolyte fluid.

Particular embodiment of this Zinc-Air battery are disclosed in the description and claimed by the dependent claims. For example, a bifunctional catalyst can be used for both reactions, as MnO₂ (alpha).

### BRIEF DESCRIPTION OF THE DRAWINGS

The terms Fig., Figs., Figure, and Figures are used interchangeably in the specification to refer to the corresponding figures in the drawings.

The above-mentioned and other features and advantages of this invention, and the manner of attaining them will become more apparent and the invention will be better understood by reference to the following description of embodiments of the invention taken in conjunction with the accompanying drawings, wherein:

FIG. 1: is a partial cutaway side view of a zinc air cell according to an embodiment of the invention;

FIG. 2: is a partial exploded view of a zinc air cell according to the embodiment shown in FIG. 1;

FIG. 3: is a part of a zinc air stack of zinc air cells arranged and connected according to one embodiment of the invention;

FIG. 4: is a top view of the cell with a serpentine flow path, suitably designed to control the electrolyte flow.

FIG. 5: is a chart showing the voltage of the battery over charging and discharging cycles over a time period of 70 hours;

FIG. 6: is a chart showing the voltage of the battery over charging and discharging cycles over a time period of approx. 2300 hours.

### DESCRIPTION OF THE INVENTION

According to the invention, the porous carbon air electrode is an oxygen reduction reaction (ORR) catalyst consisting of a porous carbon layer and either manganese oxide, particularly manganese dioxide, particularly alpha manganese dioxide, and the oxygen evolution reaction (OER) catalyst consisting of iron nickel oxyhydroxide (NiFeOOH). In a particular embodiment of this Zinc-Air battery, a bifunctional catalyst can be used for both reactions, as MnO₂ (alpha).

In a particular embodiment, the effect of the catalyst is augmented by a suitable mixture of carbon powder, comprising carbon black, graphene, expanded graphite, reduced graphene oxide, active carbon, acetylene black, carbon nanotubes and a combination or two or more thereof, to increase the conductivity of the cell in the order of 10-100 Millisiemens/Centimeter (mS cm⁻¹). Carbon powder mixture also provides additional catalytic effect to the cell as it works as a system of active sites, with an active area in the order of 20-1000 m² g⁻¹ (assessing the surface area via low-temperature gas adsorption as BET, Brunauer-Emmett-Teller (BET) method), which hosts and favors catalytic reactions of catalyst versus oxygen.

A suitable layer with hydrophobic treatment is added on the top of the catalyst to provide adhesion and durability to the structure. The hydrophobic layer is based on polymeric materials, comprising polytetrafluoroethylene (PTFE), ionomers, including perfluorosulfonic acids (PFSAs) (e.g. sulfonated tetrafluoroethylene (Nafion®), Aquivion®, Fumasep®).

The gel polymeric membrane GPM separator is a thin (from 0.1 mm to 1 mm), porous film or membrane of a polymeric material such as polypropylene or polyethylene or PVA, PAA or PAM which is treated to develop hydrophilic pores that are filled with the electrolyte. In a preferred embodiment, the polymer film is Zirfon Perl supplied by AGFA or FUMASEP FAAM by FuMA-Tech.

According to the invention, the electrolyte is made by an alkaline solution, usually NaOH or KOH or lithium hydroxide, or ammonium hydroxide, or a combination of two or more thereof (preferred molar concentration from 1 M to 7 M). The electrolyte contains at least one or more soluble zinc salts (ZnO, Zn(OH)₂, K₂Zn(OH)₄, NaZn(OH)₄, acetate (Zn(CH₃COO₂)), chloride (ZnCl₂)) with a molar concentration in the range of 0.1 to 2 M.

In a preferred embodiment of the present invention, zinc-based particles such as Zn nano particles are added to the electrolyte, which act as dispersed electrode. The concentration of zinc-based particles, with an average diameter ranging from 200 nm to 100 micrometers, can range between 1% to 50% by volume, preferably between 10% and 40% by volume (electrolyte volume). The use of this zinc-based nanoeletrolyte in the flow battery allows to obtain a higher energy density device, between 350 and 1100 Wh/kg.

Different additives are introduced in the electrolyte solution in order to act as H₂ suppressing agents and leveling agents to reduce dendrites growth during electrodeposition. These additives can comprise Mirapol® WT—Solvay, 1-Propanol, Polyethylene glycol (PEG), 1,2-Ethanediol, Urea or Thiourea, SLS, DMSO to improve the quality of the zinc deposit, or/and Tartaric acid, Citric acid to improve the Coulombic efficiency.

Corresponding reference characters indicate corresponding parts throughout the several views. The exemplifications set out herein illustrate embodiments of the invention and such exemplifications are not to be construed as limiting the scope of the invention in any manner.

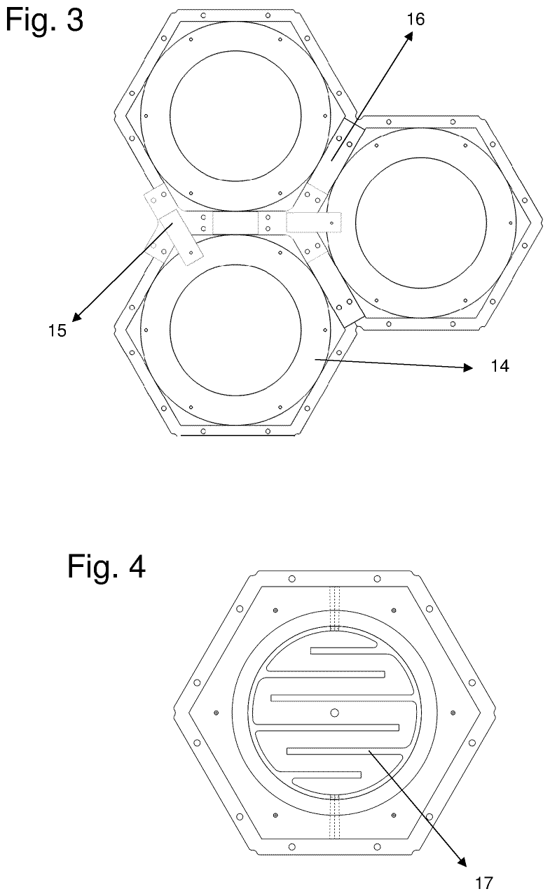

In the present embodiment, the stack comprises cells all identical and made up to create a modular structure. The structure of the stack can be modulated by means of special hooks 16 as shown in FIG. 3, and connected by electric connectors 15, based on the specific energy requests.

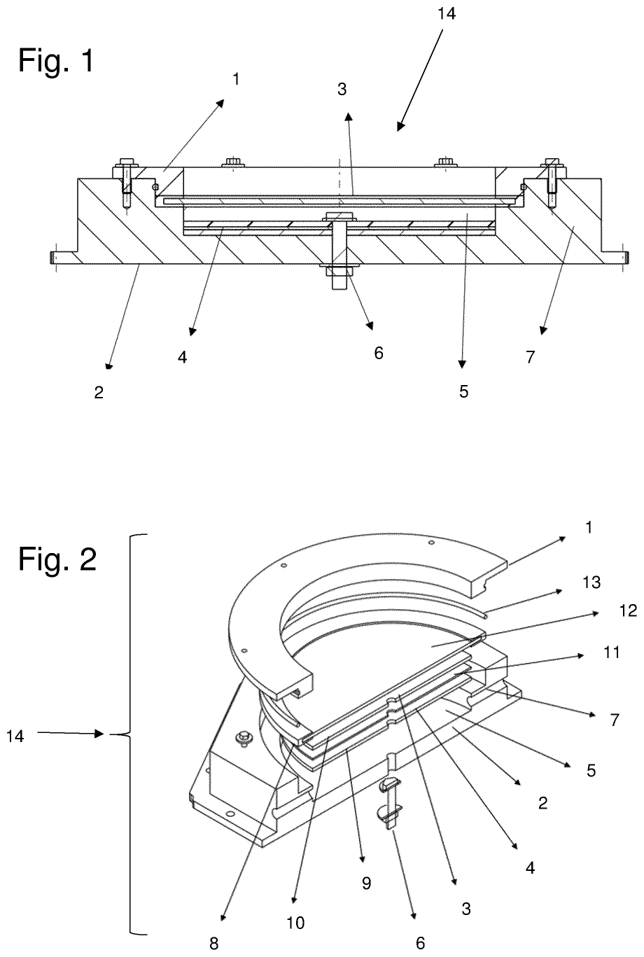

FIG. 1 shows a single zinc air cell. In the present invention, the cell chamber 5 is circular to allow a better flow of the electrolyte and to avoid areas with localized high current density. Circular shape contributes to avoid local accumulation of zinc nanoparticles or carbon particles, if used dispersed in the electrolyte. This Zinc air cell 14 includes a chamber 5 for the electrolyte flowing, a cathode 3, an anode 4, a container structure 2 of the electrolyte chamber 5 and a cathode current collector 1. A contact element 15 sown in FIG. 3 electrically connects the cathode 3 to the anode current collector 6 of the adjacent cell to close the circuit. In an alternate arrangement, contact pin and anode current collector are integrally formed. In FIG. 2, a partial exploded view of this zinc air cell is shown which allows to better identify the distinct elements.

All the elements comprised in the air cathode 12 are held together in order to guarantee a perfect mechanical tightening and seal of the cell by a silicone rubber structure 8. The silicone rubber has the double action of compacting the cathode elements and allowing the hermetic closure of the cell in an effective and lasting way, together with an O-ring 13.

The flow channels and the inlet/outlet for the electrolyte in the cell 7 may comprise length to width ratios in the ranges of 50:1 to 2:1, more in detail 25:1 to 4:1. The width of the anode flow channels may range from 2 mm to 20 cm, 5 mm to 10 cm, or 1 cm to 5 cm.

The electrolyte chamber may comprise a parallel flow configuration or a serpentine flow configuration. In a preferred embodiment, the electrolyte chamber is equipped with a special serpentine 17 as shown in FIG. 4 designed to ensure an optimal electrolyte flow, without accumulations of particles transported by the continuous flow or points of high localized current density. Providing the parallel or serpentine flow path may comprise providing channels for the parallel or serpentine flow path defined by a length to width aspect ratio of 50:1 to 2:1, 25:1 to 4:1, or 6:1 to 5:1 with respect to the diameter of the cell.

Providing the uniform flow may comprise providing a continuous pressure drop in a downstream direction in the anode chamber and a minimal pressure drop in a direction normal to the downstream direction. Providing the continuous pressure drop in the downstream direction and the minimal pressure drop in the direction normal to the downstream direction may comprise providing a parallel or serpentine flow path for the anode chamber. The flow rate of the electrolyte in the single cell chamber may range from 1 liter/min. to 7 liter/min., or 3 liter/min. to 7 liter/min., or 3 liter/min. to 5 liter/min.

FIG. 3 shows part of a zinc air stack according to one embodiment of the invention. This Zinc air stack is comprised of a plurality of stacked zinc air single cells 14 as shown in FIG. 1 and which are electrically connected by connecting elements 15. This plurality of fuel cells may be oriented horizontally and stacked on top of one another to form the fuel cell stack, or they may be oriented vertically and stacked beside one another to form the fuel cell stack.

The terms “comprise”, “comprises”, “comprised” or “comprising” may be used in the present description. As used herein, these terms are to be interpreted as specifying the presence of the stated features, integers, steps or components, but not as precluding the presence of one or more other features, integers, steps or components. It is better to specify that the present invention is not limited to the embodiment which will be discussed below. Various modifications of this embodiment are possible within the scope of the invention.

The invention includes a zinc air cell with an air cathode which is able to allow the entry of oxygen into the system, avoid the leakage of the liquid both by capillary effect and by evaporation, allow the reduction and evolution of the oxygen during the charging and discharging phases, with an optimization of the useful life of the cell up to 10 years.

In a particular embodiment, the zinc air battery includes a plurality of zinc air cells arranged in a serial manner such that all the cells can operate at the same time. According to particular implementations, the battery may include more than 100 cells and have a lifetime of 10 years.

In one embodiment, this invention provides an apparatus for charging a zinc-air cell or a zinc-air battery, said apparatus containing:
the zinc-air cell/battery,
a reservoir, said reservoir comprising a zinc-containing electrolyte fluid,
at least one external pump to drain the electrolyte fluid,
a manifold and other piping components to allow the flow of the electrolyte,
   whereby said reservoir of said apparatus is located externally to a device containing the zinc-air cells or the zinc-air battery for which charging is desired. Said pump is operationally connectible to said device and facilitates the draining of electrolyte fluid.

In the present invention, a vertical configuration of the zinc air flow battery is provided to permit, together with the continuous flow, the removal of any undesirable gas formation which is otherwise detrimental to the operation life of the system. However, due to this configuration, the cells have to withstand the pressure of the electrolyte they contain caused by gravity. This greatly increases the risk of electrolyte leakage; hence the need to implement a cathode/current collector which is not sensitive to evaporation and the capillary effect of the liquid electrolyte. In another embodiment of the same invention, a horizontal configuration can be provided.

Typically, the zinc air flow battery cell does comprise:
a carbon porous air electrode (positive electrode) for the synthesis of oxygen reduction reaction (ORR)/oxygen evolution reaction (OER) with a hydrophobic layer,
an alkaline gel polymeric membrane (GPM) with hydroxide ion conductivity or composite polymer electrolyte (CPE),
a metal negative electrode comprising zinc or zinc alloy or an inert conductive electrode where zinc deposition occurs during battery discharging, this element can be selected from carbon/graphite, based materials, stainless steel, silver, gold, platinum, titanium and alloys,
an aqueous alkaline electrolyte solution,
a casing in which said components are positioned,
an inlet and an outlet,
   wherein said inlet and said outlet are located within and traverse said casing and are constructed to permit the exchange of the aqueous electrolyte in the cell or cells and in the reservoir, this electrolyte containing a zinc-based nanoelectrofuel.

A Zinc Air flow Battery (ZAB) with a flowing electrolyte can, as previously said, overcome two of the issues regarding the use of zinc as active material for the anode. On one side, the dendrites growth is reduced due to the continuous movement of the flowing electrolyte and furthermore, the possibility for the zinc hydroxides formed during discharge to accumulate and precipitate as a passive ZnO layer is reduced. Moreover, the innovative flow field is developed to suitably assists the behavior of the viscoelastic particle-laden fluid.

In this embodiment, each cell is configured to have a positive electrode (at least one) (the air electrode) and a negative electrode (the metal electrode). The positive and negative electrodes face each other and are separated by an electrolyte solution. The space between the positive and negative electrode is predetermined. Reducing the gap between the electrodes decreases internal resistances and increases cell voltage. However, smaller amounts of deposited dendritic zinc are more likely to cause a short. The distance between the electrodes was therefore defined between 6 mm and 3 mm. To adjust the distance, a disc of plastic material, which can be PP, with a specific thickness (usually between 2 and 3 mm) is placed under the anode.

The anode described in the present invention can comprise an inert conductive electrode, like a stainless steel, nickel, iron, titanium, copper, gold, silver, magnesium, indium, lead, or carbon support, on which the zinc is deposited, or is directly composed by a conductive zinc or zinc alloy negative electrode. In some embodiments, the surface area of each of cathode and anode current collector may range from 10 cm² to 1 m².

The positive electrode is exposed to the outer surface of the metal-air cell. Since the cathode is intrinsically porous to make air pass through, this causes the electrolyte to gradually escape over time, and this event results in the formation of water on the back of the electrode. This results in the formation of crystalline KOH which reacts with CO₂ to precipitate the K₂CO₃ solids. These alkaline carbonates gradually move within the cathode porosity and block the passage of air with a consequent decrease in battery performance and life. The air cathode is an intrinsic part of the present invention.

The air cathode in the present invention comprises a catalytic layer and a current collector, and the catalytic layer comprises a catalytic air cathode material. The catalytic layer can have the role of absorbing oxygen from the air and allowing its reduction and therefore the exchange of electrons with the metal anode. At the same time the catalytic layer can allow the evolution of oxygen.

The air cathode in the present invention is obtained through sequential steps. In a preferred embodiment, the current collector material is a metal mesh of nickel, but it can also be aluminum, iron, titanium or it can be a hydrophobic carbon paper/cloth/foam onto which the catalytic materials are deposited.

An electrochemical etching treatment with acid solution (HCl or HNO₃) 0.1 to 2 M is previously done on the nickel mesh by immersion for 10 second to 10 minutes to increase the geometrical surface area, followed by a bubble templating treatment to increase its geometrical surface area. The latter is performed in a nickel bath at high current densities comprised between 0.1 and 10 A cm⁻², more preferably between 0.5 and 2 A cm⁻² for a duration ranging between 10 seconds and 10 minutes. The nickel bath contains nickel salts comprising nickel chloride (NiCl₂), sulfate (NiSO₄), sulfamate (Ni(SO₃NH₂)₂), nitrate (Ni(NO₃)₂) or a combination of those, in a concentration comprised between 0.05 M and 1 M, more preferably between 0.1 M and 0.5 M.

The catalytic materials are electrodeposited on the current collector in two steps: a first layer, to catalyze the Oxygen Reduction Reaction (ORR). The first electrodeposited catalyst may be a metal or a metal oxide. The metal is, but not limited to, at least one of the following: Ag, Pt, Pd and Au; the metal oxide may be MnO2. The morphology of the deposit highly influences the performances and the stability of the electrode and therefore the deposition conditions and the bath composition has been carefully selected for the optimal result. Finally, a layer of mixed transition metal oxides (e.g. Ni, Fe, Co), hydroxides or oxyhydroxides on top to catalyze the Oxygen Evolution Reaction (OER). Despite the large number of studies that indicate that both Ni and Fe are essential for high OER activity in a alkaline environment, a combination of Fe with NiOOH, forming a mix compound can implement the electrocatalytic behavior. This approach allows limiting the use of cobalt as element for favoring the OER, gaining a bifunctional behavior of the catalysts.

The catalytic material described in the present invention can be alpha MnO₂. It can be deposited applying anodic or cathodic current densities ranging from 1 to 100 mA cm⁻², preferably from 10 to 50 mA cm⁻² for a range of time comprised between 1 minute to 30 minutes, preferably from 1 minutes to 10 minutes. In a further embodiment of the invention, post-treatment of the as synthesizing materials can be applied, such as, acidic digestion, chemical, thermal, or thermochemical treatments in order to control the final crystallinity of the catalysts. As a further preferred embodiment, a final heat treatment is used to improve the stabilization of the morphology of the catalyst at a temperature between 300° C. and 500° C. in a controlled nitrogen atmosphere or in air for a time between 30 minutes and 3 hours.

In some aspects of the present invention, the evolution and reduction of oxygen occurs through the use of two different catalytic layers, one specifically designed for the reduction reaction and one for evolution. A single catalytic layer capable of working for both reactions can also be used.

The bifunctional air cathode can be achieved in a number of ways. For example in one aspect, it can be synthetized via thermal treatment or acid digestion of precursor elements. Different valence states and morphologies of manganese oxides catalysts were synthetized via thermal treatment of EMD (electrolytic manganese dioxide)(generating Mn₂O₃ and Mn₃O₄) and acid digestion of synthetized Mn₂O₃ (producing a-MnO₂) in order to develop an efficient Bifunctional Air Electrode (BAE).

Generation of Mn₂O₃ and Mn₃O₄ from EMD is achieved by means of a thermal method, in particular in the present invention Mn₂O₃ and Mn₃O₄ are synthetized from a commercial-grade electrolytic manganese dioxide (EMD). To obtain Mn₂O₃:heat the EMD at a temperature in the order of 500-800° C. (heating rate in the range of 2-10° C. min⁻¹) for 24-48 h in atmospheric air. On the other hand, to obtain Mn₃O₄, treat EMD at temperature higher than 700° C., particularly in the range of 900-1000° C. (temperature ramp of 10-20° C. min−1) for 2-4 h in atmospheric air. Cool down both resultant samples (Mn₂O₃ and Mn₃O₄) at room temperature in the furnace, and crush and store them in a desiccator for drying.

In another embodiment of the present invention, with the resulting Mn₂O₃ obtained with thermal treatment it is possible to proceed with the synthesis of alpha-MnO₂ via acid digestion. The acid concentration and reaction temperature of the digestion play a crucial role in defining the phase of the MnO₂. Hence, the additions of different quantities of Mn₂O₃ may change the rate determining step for the overall process, and, in consequence, the alpha-MnO₂ suitableties obtained could be different. It is necessary to add from 3 to 30 g, preferably from 10 to 20 g of as-prepared Mn₂O₃ to 1 L of 6 M H₂SO₄ (Scharlau, 98% purity) solution prepared with deionized distilled water (DDW), and keep the mixture under magnetic stirring for 16-20 h at 130-150° C. At this point the black precipitates are to be filtered and washed with ethanol and DDW. Dry the resulting solids at 110-130° C. for 2-4 hours under vacuum conditions. Let the samples cool down at room temperature.

A ink catalyst has to be prepared by adding 10 mg of powder of previous prepared catalyst to 100 μl of Nafion and 900 μl of 2-propanol. Sonicate the solution for 10 minutes and deposit it by means of a micropipette on the Nickel mesh in the range of 0.1-10 mg/cm². Leave the ink to dry at room temperature.

In a further embodiment of the present invention, Carbon-based air electrodes carrying MnO₂ are proposed. To prepare the catalyst produce a mixture of SL-30 (Solid Teflon) carbon black with specific area of 270 m²/g (Zigong carbon black, China) and acetylene black (AB) with a specific area of 70 m²/g. Teflon-30 is added as a wet-proofing agent and binder. The weight ratio of the two kinds of carbon powders is 1:1. Wet carbon powders with alcohol and then mix thoroughly with a reagent grade of 65 wt. % manganous nitrate solution at room temperature to form a slurry. The slurry has to be dried at room temperature. Calcinate the sample at a temperature in the range of 500-1000° C., better if between 700-800° C., for 1-2 hour. The mixture of carbon is suspended in alcohol and water to help the formation of the pores of air electrodes with the addiction of 30 wt % of MnO₂ powder. A two-layered air electrode has to be prepared by pressing the carbon-catalyst mixture and the nickel mesh as current collector together with a pressure of 80-100 kg/cm² and then sintering at a temperature in the range of 2500-3000° C. in atmospheric air in an oven for 2-3 hours. The final air electrode is 0.8-1 mm in thickness.

As a further embodiment of the invention, a hydrophobic layer is applied on top of the catalytic materials by any suitable deposition techniques such as spraying, dip coating, spin coating in order to immobilize the catalytic air cathode material. Furthermore the binder, which can be hydrophobic, allows the cell to retain the liquid electrolyte inside, avoiding leakages both by capillarity and by evaporation. The hydrophobic layer is based on polymeric materials, comprising polytetrafluoroethylene (PTFE), ionomers, including perfluorosulfonic acids (PFSAs) (e.g. sulfonated tetrafluoroethylene (Nafion®), Aquivion®, Fumasep®), hydrocarbons sulfonated poly(phenylene sulfone)s (e.g sulfonated polyether ether ketone (sPEEK), sulfonated polystyrene (PSS)), poly(acrylic acid) (PAA), Surlyn® or a combination of two or more thereof. This additional layer can further improve the protection and stability of the catalyst, keeping its wettability unchanged toward the alkaline GPE/CPE and the ion exchange.

To deeply deal with the leakage and carbonate formation problems, a further approach described in the present invention is the use an anionic exchange membrane as separator inserted in coupling to the air electrode, through which the cations, such as an alkali metal ion (e.g. K⁺) and a metal ion of the negative electrode (e.g. Zn 2⁺) in an alkaline electrolyte solution, cannot permeate towards the air electrode side, thus suppressing the precipitation of carbonate (K₂CO₃) and metal oxide (ZnO), which are otherwise produced in the electrode to air by a chemical reaction with carbon dioxide in the air.

With respect to the classical microporous separators typically employed in the state of the art, e.g. in patent EP 0 458 395 A1 and by Kuosch et al. (IEEE transaction, Jul. 6, 2020) the use of the suitably developed GPE/CPE, as in the present invention, guarantees:
(i) an intimate contact with the catalytic materials,
(ii) the fast and selective transport of hydroxyl ions, and
(iii) the hindering of both zinc particles and zincate ions through the air electrode, inducing damaging of the catalytic materials and short circuits of the device, thus reducing the flow battery lifetime.
   Moreover, the integration of the developed alkaline GPE/CPE guarantees a continuous availability of OH− ionic species at the air cathode, therefore the need of additional external water reservoir, as described for example in WO 2016/031201, falls.

In a preferred embodiment of the present invention, the GPE separator is a thin, porous film or membrane of a polymeric material such as polypropylene or polyethylene or PVA, PAA or PAM which is treated to develop hydrophilic pores that are configures to fill with the electrolyte. In a preferred embodiment, the polymer film is Zirfon Perl supplied by AGFA or FUMASEP FAAM by FuMA-Tech.

In another embodiment of the invention, the GPM can be modified adding organic/inorganic reinforcing particles with different aspect ratio (e.g. rod, wire, fiber, dot) comprising glass fibers, oxides, fluorine-based polymeric particles, MOFs, carbides, obtaining a composite polymer electrolyte (CPE).

The battery in a preferred embodiment comprises a flowing electrolyte, which removes zinc ions away from the anode to avoid partial saturation of zinc ions and the formation of non-soluble zinc oxides during battery discharge phase. According to the invention, the electrolyte is made by an alkaline solution, usually NaOH or KOH lithium hydroxide, ammonium hydroxide, or a combination of two or more thereof (preferred molar concentration from 1 M to 7M), in order to provide ionic conductivity (in the order of 100 mS cm⁻¹) to the solution and solubility of zinc-based salts. The electrolyte contains at least one or more soluble zinc salts (ZnO, Zn(OH)₂, K₂Zn(OH)₄, NaZn(OH)₄, acetate (Zn(CH₃COO₂)), chloride (ZnCl₂)) with a molar concentration in the range of 0.1 to 2 M that circulates by means of an external pump. In an embodiment, the zinc air battery comprises an external reservoir of electrolyte that allows high reservoir of solution with, as a consequence, higher energy density of the battery depending on the dimensions of the reservoir.

In the present invention, the Zn/Zn2+ source does not come exclusively from zinc anode and zinc compounds present in the electrolyte like the traditional employed ZnO typically used in common alkaline Zn-based flow battery, such as described in EP 0 458 395 A1 and by Kuosch et al. (IEEE transaction, Jul. 6, 2020). This approach is indeed quite limiting in terms of energy density because of the low solubility of this compound in the alkaline environment, with a molar concentration of ca. 0.5 M in saturated KOH solution.

In a preferred embodiment of the present invention, zinc-based particles such as Zn nano particles are added to the electrolyte, which act as dispersed electrode and additional source of zinc on top of which electrodeposition of metallic zinc, during the charging phase of the battery, can occur. The concentration of zinc-based particles, with an average diameter ranging from 200 nm to 100 micrometers, can be comprised between 1% to 50% by volume, preferably between 10% and 40% by volume (electrolyte volume). In a preferred embodiment zinc nanoparticles are furthermore functionalized with organic coatings comprising polyacrylic acid (PAA), polyethyleneimine (PEI), carboxymethyl cellulose (CMC), polyvinyl alcohol (PVA), oleic acid, sulfonated tetrafluoroethylene, lignin, succinic acid, chitosan and/or inorganic coatings comprising oxides and metals. Surface functionalization is essential for the use of zinc particles in order to prevent them from spontaneous dissolution but preserving their electrochemical activity in order to exploit them as dispersed electrode. Functionalization is limited to some, particularly from 2 to 10, surface layers of the organic molecules physically or chemically adsorbed onto the zinc surface to achieve such behavior. The zinc nanoparticles must be prepared before their dispersion into the alkaline electrolyte.

The use of this zinc-based nanoeletrolyte in the flow battery of the present invention allows to obtain a higher energy density device, between 350 and 1100 Wh/kg. In some embodiment of the invention, different additives are introduced in the electrolyte solution in order to act as H₂ suppressing agents and leveling agents to reduce dendrites growth during electrodeposition. These additives can comprise Mirapol® WT—Solvay, 1-Propanol, Polyethylene glycol (PEG), 1,2-Ethanediol, Urea or Thiourea, SLS, DMSO to improve the quality of the zinc deposit, or/and Tartaric acid, Citric acid to improve the Coulombic efficiency.

In still another embodiment of the invention, thickeners compounds, added to stabilize zinc-based particles' dispersion in the electrolyte, are dissolved in the previously shown formulation. The group of thickener compounds can comprise sodium alginate, xanthan gum and polyacrylic acid (PAA), added to the nanoeletrofuel in an amount comprised between 0.1 wt. % and 5 wt. %, preferably between 0.5 wt. % and 3 wt. %.

In yet another embodiment of the invention, to the previously described formulation of the zinc-based nanoeletrofuel, high active area carbon-based compounds (of the order of 20-1000 m² g⁻¹), comprising carbon black, graphene, expanded graphite, reduced graphene oxide, active carbon, acetylene black, carbon nanotubes and a combination or two or more thereof, are introduced in order to form a percolated slurry with electronic conductivity in the order of 10-100 Millisiemens/Centimeter (mS cm⁻¹). High surface area carbon have been suitably synthesized via chemical, mechanical or electrochemical scalable processes, assessing the surface area suitableties via low-temperature gas adsorption as BET, Brunauer-Emmett-Teller (BET) method. The concentration of carbon particles in the electrolyte solution is comprised between 0.1 wt. % and 10 wt. %.

### Performance and Upscale:

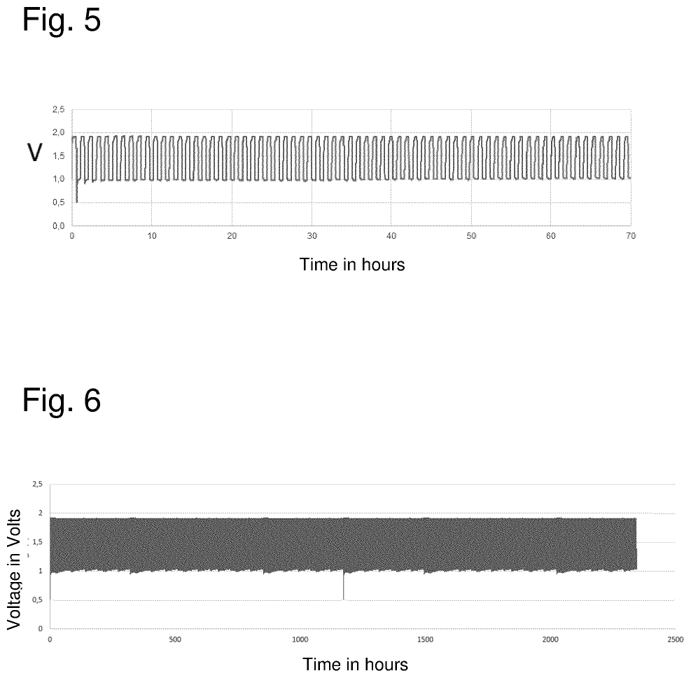

The cell described in the present invention, therefore characterized by the presence of:
carbon porous air electrode with:
   ORR: manganese dioxide in alpha form produced according to procedure
   OER: FeNiOOH electrodeposited according to procedure
carbon powder and hydrophobic layer PTFE made according to the dosages defined above demonstrated to work with a charge voltage between 1.7-2 V and a discharge voltage between 0.8-1.3 V with current density from 5 mA/cm² to 50 mA/cm², voltage (V) on the y axis and time (cycles or hours) on the x axis. The results are displayed in FIGS. 5 and 6. The described cell worked with the previously indicated parameters without malfunctions and losses for 12 months non-stop, more precisely with 1 hour charge and discharge cycles (more than 8,000 cycles with each 1 hour duration).

The specifications of the present invention can be selected at need depending on the application due to the great flexibility of the flow battery system, from kW/kWh to MW/MWh range by increasing the size of the nanoelectrofuel tank. Indeed, the advantages of the adoption of a flow technology are above all the decoupling of power and energy, and the easy scalability of the system. A long lifetime of at least 10 years is guaranteed with minimal maintenance in that period and a stability of 5,000-15,000 cycles is expected without appreciable losses of capacity.

Such a rechargeable battery has many applications. For example, it can be used for the propulsion of vehicles on land, on water, in the air. More particularly, it can be used for the powering of consumer electronics, power tools, measuring instruments vehicles, the propulsion of partly or fully electrically powered bicycles, motorcycles, cars, trucks, baggers, cranes on land, partly or fully electrically powered boats, ships, submarines on or in water, partly or fully electrically powered aircraft such as helicopters, ultralight planes, microlight planes, ecolight planes, single and multiengine planes, fighters, transportation planes, airliners, hot air and gas balloons and airships in the air, space application, as permanent rechargeable power sources for houses and industrial sites, military applications, power systems of all sorts.

1. A Zinc-Air rechargeable flow battery having zinc-air cells comprising:
at least one air electrode as positive electrode for the synthesis of oxygen reduction reaction ORR and oxygen evolution reaction OER;
an alkaline gel polymeric membrane GPM with hydroxide ion conductivity or a composite polymer electrolyte CPE,
at least one metal negative electrode comprising zinc or zinc alloy or an inert conductive electrode where zinc deposition occurs during battery discharging, this conductive electrode made of carbon/graphite, based materials, stainless steel, silver, gold, platinum, titanium and alloys of these,
an aqueous electrolyte solution adapted to flow through the housing,
wherein the battery incorpates an intregrated dlow system in that the air electrode is a porous carbon air electrode acting as an oxygen reduction reaction ORR catalyst and consisting of manganese oxide, and the oxygen evolution reaction OER catalyst consisting of iron nickel oxyhydroxide NiFeOOH, and the electrolyte containing a zinc-based nanoelectrofuel.

2. (canceled)

3. (canceled)

4. A Zinc-Air rechargeable flow battery according to claim 1, wherein the top of the catalyst is equipped with a hydrophobic layer of polymeric materials, comprising polytetrafluoroethylene PTFE, ionomers, including perfluorosulfonic acids PFSAs, in order to provide adhesion and durability to the structure.

5. A Zinc-Air rechargeable flow battery according to claim 1, wherein the gel polymeric membrane GPM separator is a thin, porous film or membrane of a polymeric material of 0.1 mm to 1 mm thickness of polypropylene or polyethylene or PVA, PAA or PAM which is treated to develop hydrophilic pores that are filled with the electrolyte.

6. A Zinc-Air rechargeable flow battery according to claim 1, wherein the aqueous electrolyte solution is made by an alkaline solution, that is NaOH or KOH or lithium hydroxide, or ammonium hydroxide, or a combination of two or more thereof with a molar concentration from 1 M to 7 M), and the electrolyte contains at least one or more soluble zinc salts of a selection ZnO, Zn(OH)₂, K₂Zn(OH)₄, NaZn(OH)₄, acetate Zn(CH₃COO₂), chloride (ZnCl₂) with a molar concentration in the range of 0.1 to 2 M.

7. A Zinc-Air rechargeable flow battery according to claim 1, wherein zinc-based particles such as Zn nano particles are added to the electrolyte which act as dispersed electrode, the electrolyte having a concentration of zinc-based particles between 1% to 50% by volume, preferably between 10% and 40% by the electrolyte volume, and the particles having an average diameter ranging from 200 nm to 100 micrometers.

8. A Zinc-Air rechargeable flow battery according to claim 1, wherein one or more additives are contained in the electrolyte solution, out of a selection of these components: Mirapol® WT—Solvay, 1-Propanol, Polyethylene glycol PEG, 1,2-Ethanediol, Urea or Thiourea, SLS, DMSO as H₂ suppressing agents and leveling agents to reduce dendrites growth during electrodeposition and in order to improve the quality of the zinc deposit, or/and Tartaric acid, Citric acid in order to improve the Coulombic efficiency.

9. A Zinc-Air rechargeable flow battery according to claim 1, having zinc-air cells, wherein it comprises a casing in which all components are positioned, and an inlet and an outlet, wherein said inlet and said outlet are located within and traverse said casing and are constructed to permit the exchange of the aqueous electrolyte in the cell and in the reservoir.

10. A Zinc-Air rechargeable flow battery according to claim 9, wherein the Zinc air stack is comprising of a plurality of vertically or horizontally stacked zinc air single cells, this stack comprising cells all identical and made up to create a modular structure, and the structure of the stack in modular in dessin by attaching several air single cells by hooks and electrical connectors to meet specific energy requests.

11. The Zinc-Air rechargeable flow battery according to claim 1, wherein the cell chamber of the cells is circular to allow a better flow of the electrolyte and to avoid areas with localized high current density, and each of the Zinc air cells comprises a chamber for the electrolyte flowing, a cathode, an anode, a container structure of the electrolyte chamber and a cathode current collector, whereby a contact element electrically connects the cathode to the anode current collector of the adjacent cell to close the circuit, and whereby a contact pin and anode current collector are integrally formed, and all elements comprised in the air cathode are held together by a silicone rubber structure, together with an O-ring.

12. A Zinc-Air rechargeable flow battery according to claim 1, wherein the flow channels and the inlet/outlet for the electrolyte in the cells comprise a length to width ratio in the ranges of 50:1 to 2:1 and the electrolyte chamber comprises a parallel flow configuration or a serpentine flow configuration, designed to ensure an optimal electrolyte flow, without accumulations of particles transported by the continuous flow or points of high localized current density, the parallel or serpentine flow path providing channels for the parallel or serpentine flow path defined by a length to width aspect ratio of 50:1 to 2:1 with respect to the diameter of the cell.

13. An apparatus for charging a zinc-air rechargeable flow cell or a zinc-air rechargeable flow battery, said apparatus containing: the zinc-air cell/battery, a reservoir, said reservoir comprising a zinc-containing electrolyte fluid, at least one external pump to drain the electrolyte fluid, a manifold and other piping components to allow the flow of the electrolyte, whereby said reservoir of said apparatus is located externally to a device containing zinc-air cell or zinc-air battery for which charging is desired and said pump is operationally connectible to said device and facilitates the draining of electrolyte fluid.

14. Use of a Zinc-Air rechargeable flow battery having zinc air cells according to claim 1, for partly or fully propelling vehicles on land, such as bicycles, motorcycles, cars, trucks, baggers, cranes on land, vehicles on water such as boats and ships of any type, or submarines on or in water, vehicles in the air such as helicopters, ultralight planes, microlight planes, ecolight planes, single and multiengine planes, fighters, transportation planes, airliners, hot air and gas balloons and airships in the air, and for use as permanent rechargeable power sources for houses and industrial sites, military applications and power systems of all sorts.

15. The Zinc-Air rechargeable flow battery according to claim 1,
wherein a bifunctional catalyst is present which is usable for both the oxygen reduction reaction ORR and the oxygen evolution reaction OER, and the ORR catalyst is consisting of manganese dioxide or alpha manganese dioxide, and that its catalyst effect is augmented by containing a mixture of carbon powder, comprising a combination of two or more of a selection of carbon black, graphene, expanded graphite, reduced graphene oxide, active carbon, acetylene black and carbon nanotubes.
